(19) United States
(12) Patent Application Publication
(10) Pub. No.: US 2012/0037613 A1
(43) Pub. Date: Feb. 16, 2012

(54) ELEMENT WIRE CONTACT PREVENTION MEMBER AND METHOD FOR MAINTENANCE OF HEATER DEVICE

(75) Inventor: Shinya OHTAKE, Fuchu City (JP)

(73) Assignee: TOKYO ELECTRON LIMITED, Tokyo (JP)

(21) Appl. No.: 13/205,235

(22) Filed: Aug. 8, 2011

(30) Foreign Application Priority Data
Aug. 10, 2010 (JP) 2010-179592

(51) Int. Cl. H05B 3/02

(52) U.S. Cl. 219/546; 29/428

(57) ABSTRACT

An insulative element wire contact prevention member is installed in a heater device having heater element wires spirally wound around the circumference of an object to be heated. The element wire contact prevention member is interposed between the heater element wires in a portion at which a gap between the heater element wires becomes narrower than that at the time of arrangement of the heater element wires due to deformation of the heater element wires.

### CROSS-REFERENCE TO RELATED APPLICATION

This application claims the benefit of Japanese Patent Application No. 2010-179592, filed on Aug. 10, 2010, in the Japan Patent Office, the disclosure of which is incorporated herein their entirety by reference.

### TECHNICAL FIELD

The present disclosure relates to a method for maintenance of a heater device installed in a heating apparatus for heat treatment of an object to be heated, such as a semiconductor wafer or the like, and an element wire contact prevention member for preventing contact between element wires.

### BACKGROUND

In general, a semiconductor wafer formed of a silicon substrate or the like is repeatedly subjected to the processes of film formation, oxidation, diffusion, annealing, etching, and so on in order to form a semiconductor integrated circuit. In addition, in performing these processes, a so-called batch type heat treatment apparatus is used for simultaneous treatment of a plurality of semiconductor wafers. For example, such a heat treatment apparatus includes an elongated quartz processing container. Specifically, in the elongated quartz processing container, a plurality of semiconductor wafers is accommodated in a wafer boat supported by over a plurality of stages and hermetically sealed. In this example, it is arranged that the atmosphere within this processing container is exhausted by an exhaustion unit while required process gas is being fed into this processing container by a gas feed means.

In addition, a heater device for heating the semiconductor wafers is placed to surround an outer circumference of this processing container. For example, this heater device is formed by spirally winding a heater element wire around an inner circumference of a cylindrical adiabatic layer. A pitch (gap) of this spiral heater element wire is set to be, for example, about 10 to 30 mm. The semiconductor wafers are then subjected to heat treatment such as film formation treatment, oxidation treatment, or annealing treatment while being heated to a predetermined temperature by the heater device.

However, the heater element wire, which is used in the heater device applied for the heating apparatus as described above, cannot avoid permanent elongation which results from its repeated use. The term “permanent elongation” refers to elongation resulted from deterioration of the heater element wire itself, but it does not refer to thermal elongation and contraction generated by heating and/or cooling.

Such permanent elongation may lead to deformation of the spirally-wound heater element wire itself. This may cause a problem that, when the heater element wire is deformed to be bent to contact an adjacent heater element wire, excessive heat is generated due to contact resistance of the contact portion so that the contact portion is fused, or, in worst case, the wire may be disconnected due to a spark or the like.

### SUMMARY

The present disclosure provides some embodiments of an element wire contact prevention member for preventing contact between heater element wires and a method for maintenance of a heater device.

According to one embodiment of the present disclosure, there is provided an insulative element wire contact prevention member which is installed in a heater device having heater element wires spirally wound around the circumference of an object to be heated, wherein the element wire contact prevention member is interposed between the heater element wires in a portion at which a gap between the heater element wires becomes narrower than that at the time of arrangement of the heater element wires due to deformation of the heater element wires.

According to another embodiment of the present disclosure, there is provided an insulative element wire contact prevention member which is installed in a heater device having heater element wires having a wave shape or a bent shape of a repeated U-turn pattern disposed on the circumference of an object to be heated, wherein the element wire contact prevention member is interposed between the heater element wires in a portion at which a gap between the heater element wires becomes narrower than that at the time of arrangement of the heater element wires due to deformation of the heater element wires.

According to another embodiment of the present disclosure, there is provided a method for maintenance of a heater device which includes heater element wires spirally wound around the circumference of an object to be heated, comprising: detecting a portion at which a gap between the heater element wires becomes narrower than that at the time of arrangement of the heater element wires due to deformation of the heater element wires; and installing an element wire contact prevention member according to the above embodiment between the heater element wires in the narrowed portion.

According to another embodiment of the present disclosure, there is provided a method for maintenance of a heater device which includes heater element wires having a wave shape or a bent shape of a repeated U-turn pattern disposed on the circumference of an object to be heated, comprising: detecting a portion at which a gap between the heater element wires becomes narrower than that at the time of arrangement of the heater element wires due to deformation of the heater element wires; and installing an element wire contact prevention member according to the above embodiment between the heater element wires in the narrowed portion.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a schematic configuration view showing one example of a heat treatment apparatus having a heater device to which an element wire contact prevention member is applied according to an embodiment of the disclosure.

FIG. 2 is a sectional view of the heater device.

FIG. 3 is an enlarged sectional view of a portion of the heater device.

FIG. 4 is a perspective view of one example of the element wire contact prevention member according to an embodiment of the disclosure.

FIG. 5 is a sectional view of a heater device illustrating narrowed gaps between heater element wires due to deformation of the wire.

FIG. 6 is an enlarged sectional view of a heater device where an element wire contact prevention member is mounted between the heater element wires in a narrowed gap portion.

FIG. 7A is a photograph showing a state that an element wire contact prevention member is not mounted between heater element wires.

FIG. 7B is a photograph showing a state that an element wire contact prevention member is interposed and mounted between heater element wires.

FIG. 8A is a view of an example of embodiment demonstrating a modification of the element wire contact prevention member.

FIG. 8B is an enlarged sectional view of a heater device where the modified element wire contact prevention member, which is shown in FIG. 8A, is mounted and interposed between heater element wires in a narrowed portion.

FIG. 9 is a view showing a modification of arrangement of the heater element wire.

### DETAILED DESCRIPTION

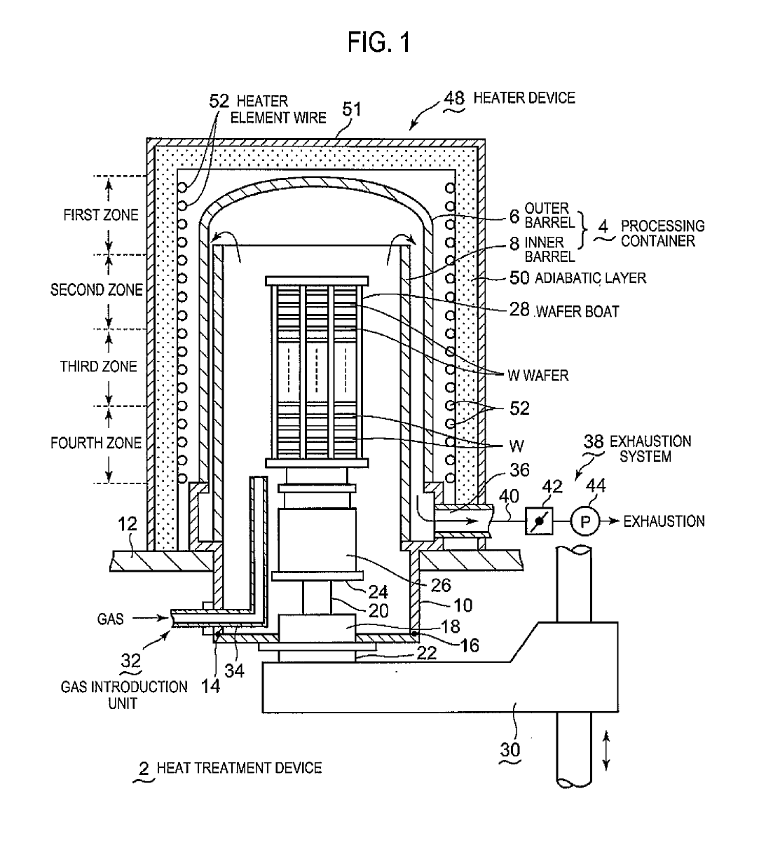

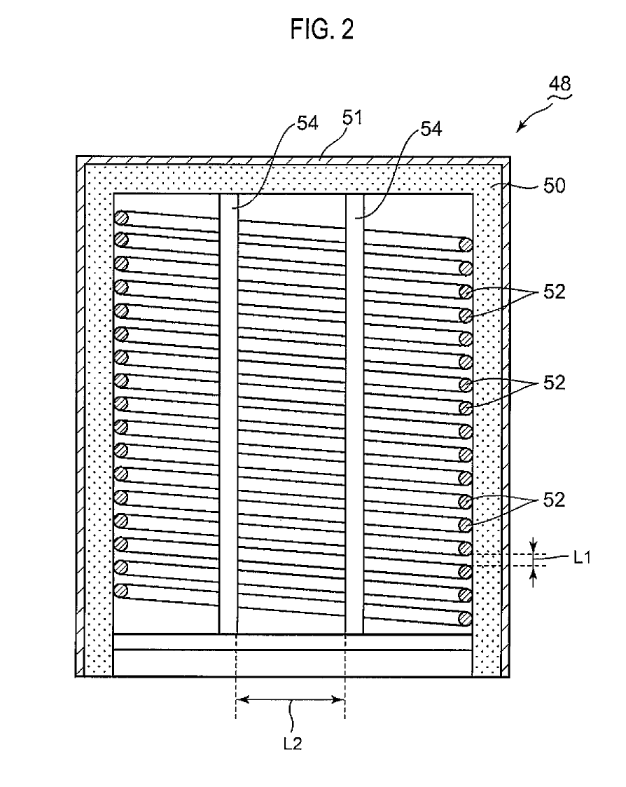

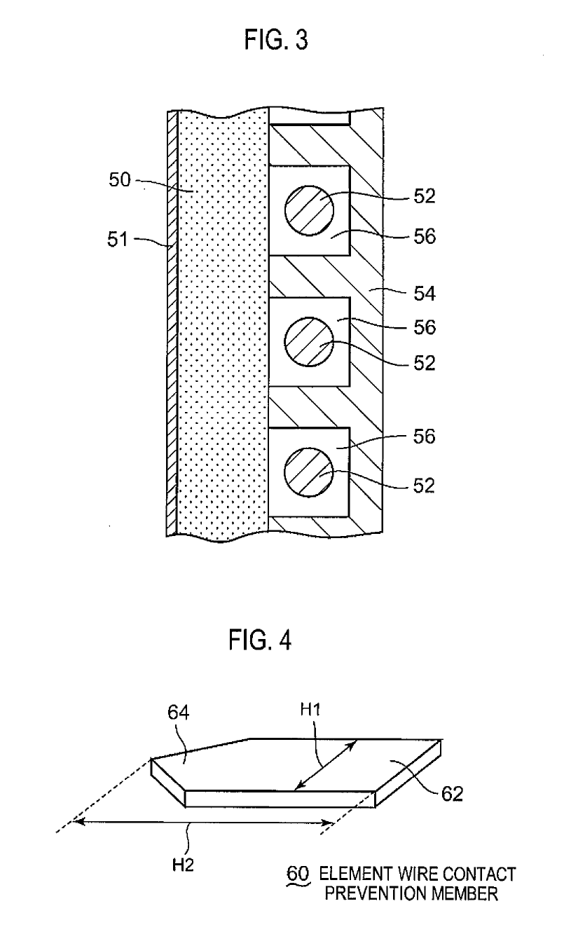

An embodiment of an element wire contact prevention member and a method for maintenance of a heater device will now be described in detail with reference to the drawings. FIG. 1 is a schematic configuration view of one example of a heat treatment apparatus having a heater device to which an element wire contact prevention member is applied according to an embodiment of the disclosure. FIG. 2 is a sectional view of the heater device, and FIG. 3 is an enlarged sectional view of a portion of the heater device. FIG. 4 is a perspective view of one example of the element wire contact prevention member according to an embodiment of the disclosure. In the following description, an object to be heated will be illustrated with a semiconductor wafer.

To begin with, a heat treatment apparatus will be described below. As shown in FIG. 1, this vertical heat treatment apparatus 2 includes a cylindrical processing container 4 whose longitudinal direction lies vertically. This processing container 4 has a double tube structure, which generally comprises an outer barrel 6 which is made of a heat-resistant material, for example, quartz, and an inner barrel 8 which is concentrically placed inside of the outer barrel 6 and is made of, for example, quartz. The outer barrel 6 and the inner barrel 8 have their respective bottoms which are supported by a manifold 10 which is made of stainless steel or the like and is fixed to a base plate 12.

In addition, a disc-like cap 14 made of, for example, stainless steel or the like, is air-tightly mounted in an opening at the bottom of the manifold 10 with a seal member 16 such as an O-ring. A rotatable shaft 20 is inserted in substantially the center of the cap 14 under an airtight state produced by, for example, a magnetic fluid seal 18. The bottom of the shaft 20 is connected to a rotation mechanism 22 and the top thereof is fixed to a table 24 made of, for example, stainless steel.

Further, a heat reservoir 26 made of quartz is placed on the table 24 and a wafer boat 28 made of, for example, quartz is loaded, as a holder, on the heat reservoir 26, A plurality of (e.g., 50 to 150) semiconductor wafers W as objects to be heated is accommodated in the wafer boat 28 with a pitch of, for example, 10 mm therebetween. The wafer boat 28, the heat reservoir 26, the table 24, and the cap 14 are integrally loaded/unloaded into/from the processing container 4 by means of an elevating mechanism, such as a boat elevator 30. A gas introduction unit 32 for introducing required gas into the processing container 4 is placed in a lower portion of the manifold 10.

The gas introduction unit 32 has a gas nozzle 34 which is airtightly installed through the manifold 10. Although only one gas nozzle is shown in this example, one or more gas nozzles 34 may be actually provided depending on the kind of gas used. The required gas is introduced into the processing container 4 under control of its flow rate by the gas nozzle 34. In addition, a gas outlet 36 is provided in an upper portion of the manifold 10 and is connected to an exhaustion system 38. Specifically, the exhaustion system 38 has an exhausting passage 40 connected to the gas outlet 36. Further, a pressure regulating valve 42 and a vacuum pump 44 are disposed in order in the course of the exhausting passage 40, thereby allowing the internal atmosphere of the processing container 4 to be exhausted with its regulated pressure. Additionally, a processing container made entirely of quartz without providing any manifold 10 has also been known.

In addition, a heater device 48 for heating the wafers W is provided to surround the outer circumference of the wafers W or the processing container 4. Specifically, the heater device 48 includes a cylindrically-shaped adiabatic layer 50 which surrounds the outer circumference of the processing container 4 and has a ceiling. This adiabatic layer 50 is made of, for example, a mixture of silica and alumina, which are low thermal-conductive, flexible, and amorphous, and has a thickness of about 2 to 4 cm. The inner surface of the adiabatic layer 50 is separated by a predetermined distance from the outer surface of the processing container 4. In addition, a protection cover 51 made of, for example, stainless steel, is mounted on the outer circumference of the adiabatic layer 50 to cover its entire surface.

In addition, a heater element wire 52 is disposed to spirally wind around the inner circumference of the adiabatic layer 50. In this example, the heater element wire 52 is disposed to wind throughout the overall side of the adiabatic layer 50 and is arranged to cover the overall height of the processing container 4. In other words, it is configured that the adiabatic layer 50 is disposed on the outer circumference of the heater element wire 52. The spirally wound heater element wire 52 has a pitch, for example, in a range of 10 to 30 mm and a diameter in a range of 1 to 14 mm. Accordingly, the distance L1 (see FIG. 2) between adjacent heater element wires 52 in the vertical direction is set to be, for example, in a range of 5 to 16 mm.

Material for this heater element wire 52 is formed by a resistance heating conductor which includes, for example, iron, chromium, aluminum, or the like as main material. For example, a Kanthal heater (registered trademark) may be used as the heater element wire 52. Alternatively, other carbon wire heaters may be used as the heater element wire 52.

In this example, the heater element wire 52 is divided into a plurality of zones in the height direction, for example, four zones from the first to the fourth zone, each of which may be independently temperature-controlled based on temperature detected by a thermocouple (not shown) provided in the adiabatic layer 50 for each of the zones. The number of zones for division is not limited to the above value.

In this example, if a heat treatment apparatus for wafers with 300 mm of diameter is used, the diameter of the heater device is about 600 mm. The length of the heater element wire 52 for each of the first to fourth zones is set to be for example, in a range of ten to several tens meters. in addition, as shown in FIG. 2, a plurality of element wire holding frames 54 extending in the vertical direction is disposed at a predetermined equal interval along the inner circumference of the cylindrically-shaped adiabatic layer 50.

As shown in FIG. 3, these element wire holding frames 54 have a shape like a concavo-convex comb, in which heater element wires 52 are accommodated in concave portions 56 to prevent misalignment of the heater element wires 52. The distance L2 (see FIG. 2) between adjacent element wire holding frames 54 is set to be, for example, in a range of 10 to 15 cm. These element wire holding frames 54 are made of insulative ceramic material.

When a repeated heat treatment for the semiconductor wafers W is performed using the above-configured heat treatment apparatus 2, the heater element wire 52 may undergo deformation with time, which may result in permanent elongation of the heater element wire 52, thereby producing portions with a narrower gap between the wires than that of the initial arrangement. An element wire contact prevention member 62 according to an embodiment of the present disclosure, shown in FIG. 4, is mounted in the narrowed portion between the heater element wires 52 when performing maintenance of the heater device. This element wire contact prevention member 62 is formed of a plate-like member 62 and made of an insulative material.

This plate-like member 62 is made into a rectangular shape and has an acute-angled leading end 64, which is so designed that it can be easily inserted into the flexible adiabatic layer 50. The thickness of this plate-like member 62 is set to be within a range of 0.5 to 5 mm, for example, 1.5 mm in this example. Its width H1 is set to be within a range of 5 to 30 mm, for example, 10 mm in this example. Its length H2 is set to be within a range of 20 to 50 mm, for example, 40 mm in this example.

In addition, this plate-like member 62 may be preferably rigid, insulative, and heat-resistant and be made of, for example, ceramic material. An example of this ceramic material may include, for example, alumina (Al₂O₃), aluminum nitride (AlN), or the like.

Next, a method for maintenance of the heater device used in the above-configured heat treatment apparatus will be described. First, the reference is made to heat treatment of semiconductor wafers W. The wafer boat 28 with a plurality of raw wafers W loaded thereon is accommodated in the processing container 4 by being ascended by the boat elevator 30 from below the processing container 4, and the opening at the bottom of the container is hermetically sealed by the cap 14. Then, the processing container 4 is vacuumized below a predetermined pressure using the exhaustion system 38, and at the same time, the wafers W are heated to a predetermined treatment temperature at which heat treatment is carried out, by increasing electric current applied to the heater element wire 52 of the heater device 48, and maintained at the predetermined temperature. Then, a regulated process gas is introduced from the gas nozzle 34 of the gas introduction unit 32 at the lower portion of the processing container 4 into the processing container 4, and then, heat treatment is carried out by making the gas flow upward in the inner barrel 8 and flow between the wafers.

The gas flowing in the inner barrel 8 rebounds from the ceiling of the processing container 4 and is discharged out by the exhaustion system 38 through a gap between the inner barrel 8 and the outer barrel 6, as described above. The heat treatment carried out in this example may include treatments such as film formation, oxidation, diffusion, and annealing, in each of which different process gas is used depending on the type of treatment. The treatment temperature is also varied depending on the type of treatment. For example, the heat treatment is carried out at a high temperature in a range of 300 to 800° C.

When the above heat treatment is repeated for the semiconductor wafers W, the heater element wire 52 may undergo deformation with time, as described above, which may result in permanent elongation of the heater element wire 52, thereby producing portions with a narrower gap between the wires than that at the initial arrangement of the element wire. In this case, the heater element wire 52 is elongated, for example, by about 0.00085% per heat treatment (1 RUN).

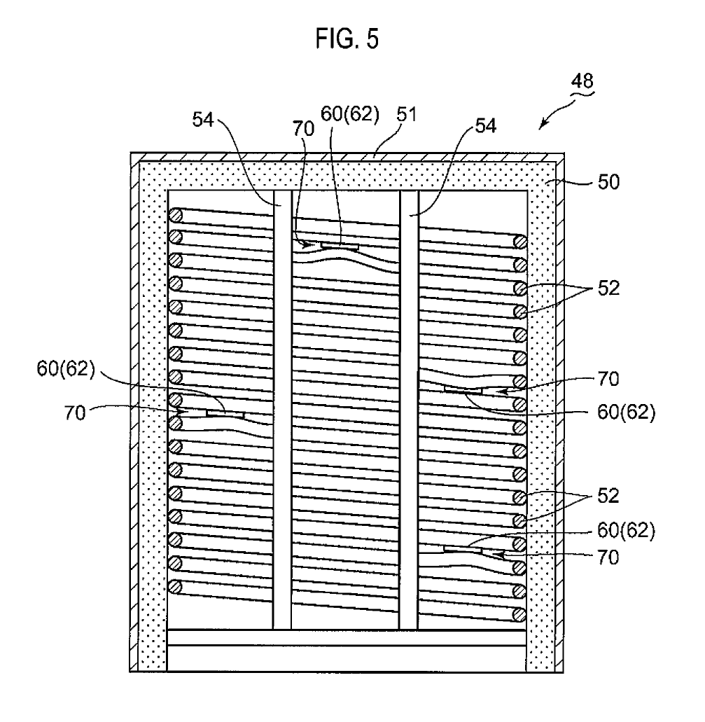

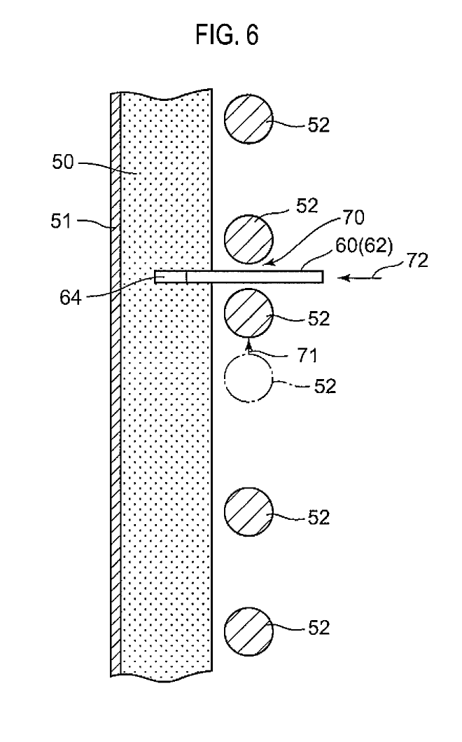

The portion with a narrower gap between the heater element wire 52 than that at the time of initial arrangement of the wire (at the time of manufacturing) may be observed by an operator in a regular or irregular maintenance operation or the like. FIG. 5 is a sectional view of a heater device illustrating narrowed gaps between the heater element wires due to deformation of the wire, and FIG. 6 is an enlarged sectional view of a heater device where an element wire contact prevention member is mounted between the heater element wires in a narrowed gap portion. In FIG. 6, a portion of the heater element wire 52 is deformed, as indicated by an arrow 71, to produce a narrowed portion 70 between the heater element wires 52. When the narrower portion 70 is observed as described above, an operator installs the element wire contact prevention member 60, as shown in FIG. 4, in the narrowed portion 70 between the heater element wires 52.

At this installation, the leading end 64 of the element wire contact prevention member 60 comprising the plate-like member 62 having the acute-angled leading end 64 is inserted into the flexible adiabatic layer 50 so that it can be interposed between the heater element wires 52 at the narrowed portion 70, as indicated by an arrow 72 in FIG. 6. In FIG. 5, the element wire contact prevention member 60 is disposed in every narrowed portion 70 to be interposed between the heater element wires 52.

In this manner, as the element wire contact prevention member 60 is disposed in the portion at which a gap between the heater element wires is narrowed, it is possible to prevent contact between the heater element wires 52. This can prevent fusion and disconnection between heater element wires, and hence extend durability of the heater element wire. Such a maintenance operation is performed, for example, once or several time a year.

As described above, according to the above embodiment, as the element wire contact prevention member 60 is interposed between the heater element wires 52 in the portion 70 at which the gap between the heater element wires 51 becomes narrower than that at the time of the initial arrangement of the heater element wire 52 due to deformation of the heater element wire 52, it is possible to prevent contact, fusion, and disconnection between the heater element wires 52.

### <Actual Mounting State of Element Wire Contact Prevention Member>

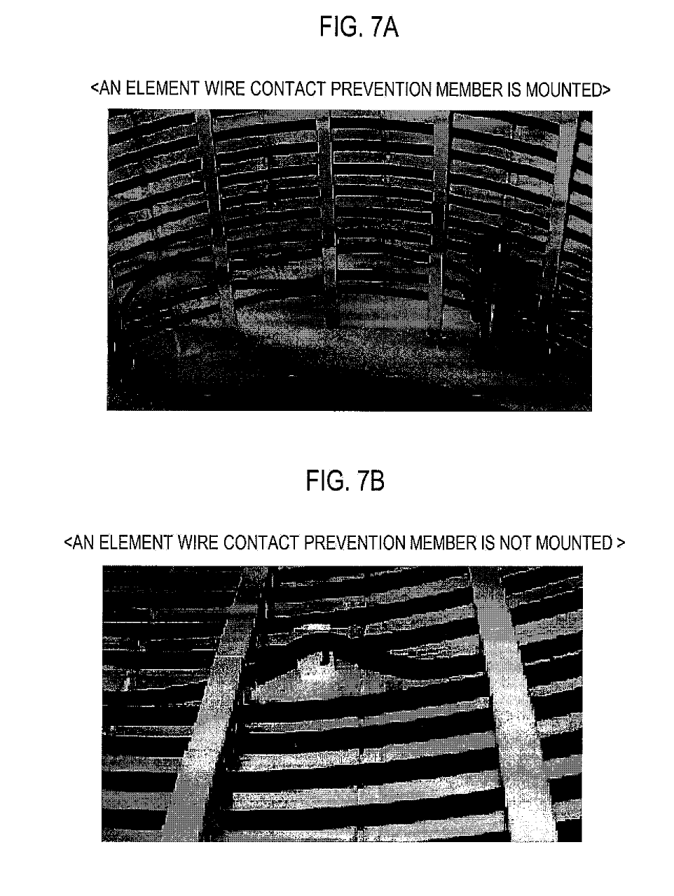

Next, with reference to FIGS. 7A and 7B, a state in which the above-described element wire contact prevention member 60 is actually disposed and mounted and a state in which the member 60 is not disposed will be described. FIG. 7A is a photograph showing a state that an element wire contact prevention member is not mounted between heater element wires. FIG. 7B is a photograph showing a state that an element wire contact prevention member is interposed and mounted between heater element wires.

As shown in FIG. 7A, where permanent elongation is produced due to repeated use of the heater device and a narrowed gap between heater element wires due to deformation or bend of the heater element wires is left as it is, contact between adjacent heater element wires may produce a spark or the like to fuse the heater element wires. On the contrary, as shown in FIG. 7B, when the insulative element wire contact prevention member according to an embodiment of the present disclosure is provided in a portion at which a gap between the heater element wires is narrowed due to deformation or bend of the heater element wires, it is possible to prevent contact and fusing between the heater element wires even in later use.

The typical average lifespan of the heater element wires was about 22 months. However, where the element wire contact prevention member 60 is interposed and mounted during actual maintenance of the heater device of the heat treatment apparatus, the average lifespan of the heater element wires has extended to about 42 months.

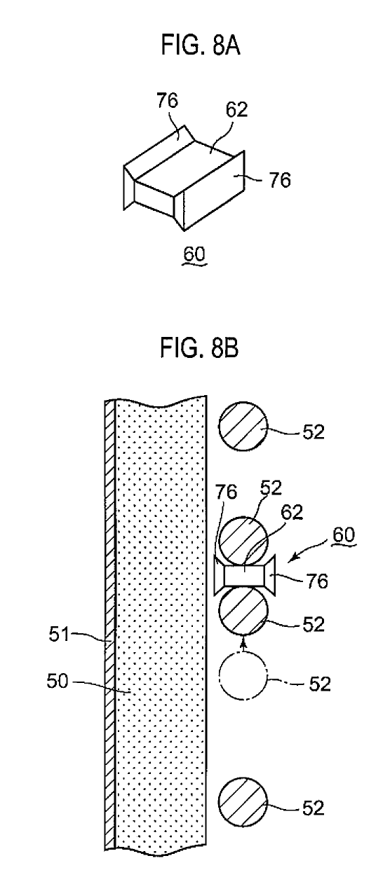

Although it has been illustrated in the above embodiment that the element wire contact prevention member 60 is supported by penetrating its leading end into the adiabatic layer 50, the present disclosure is not limited thereto, but the element wire contact prevention member 60 may be supported by inserting it between the heater element wires 52 with a gap therebetween narrowed. In this case, as a modification of the element wire contact prevention member 60, shown in FIG. 8A, it is preferable that separation prevention projections 76 are provided in both ends of the plate-like member 62 to prevent the element wire contact prevention member 60 from being separated from the heater element wires 52. FIG. 8B is an enlarged sectional view of a heater device where the modified element wire contact prevention member, which is shown in FIG. 8A, is mounted and interposed in a narrowed portion between the heater element wire.

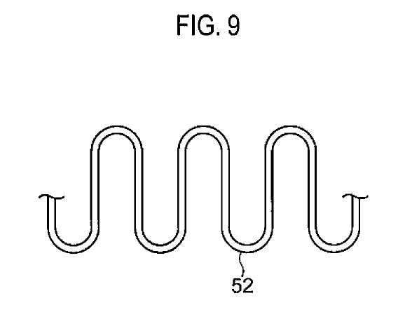

In addition, although it has been illustrated in the above embodiment that the heater element wire 52 of the heater device 48 is spirally wound, the present disclosure is not limited thereto, but the heater element wire 52 may have any other shape of arrangement. FIG. 9 is a view showing a modification of arrangement of the heater element wire 52. In this modification, the heater element wire 52 has a wave shape or a bent shape having a repeated U-turn pattern instead of the spiral shape. The element wire contact prevention member 60 according to an embodiment of the present disclosure may be also applied to the heater element wire 52 having such a shape.

In addition, although it has been illustrated in the above embodiment that the heat treatment apparatus is exemplified as the processing container 4, which is formed in the double tube structure and has the inner barrel 8 and the outer barrel 6, the present disclosure is not limited thereto, but may be applied to the processing container 4 having a single tube structure. In addition, although the heater device 48 installed in the heat treatment apparatus 2 has been illustrated in the above embodiment, the present disclosure is not limited thereto, but may be applied to, for example, a drier, an electric furnace, or the like, which is configured such that an object to be heated is accommodated in a container and the heater device 48 is arranged on the outer circumference of the container. Such a drier may dry, for example, quartz parts as well as cleaned semiconductor wafers. As another example, such an electric furnace may be used to manufacture glass, ceramics and so on.

In addition, although it has been illustrated in the above embodiment that the heater element wire 52 has the circular cross-section, the shape of cross-section of the heater element wire 52 is not limited to a specific one. For example, the present disclosure may be applied to a plate-like heater element wire having a rectangular cross-section.

In addition, although it has been illustrated in the above embodiment that the semiconductor wafers mainly made of a silicon substrate are employed as objects to be heated, the present disclosure is not limited thereto. For example, the semiconductor wafers according to the present disclosure may include, but is not limited to, a silicon substrate, a compound semiconductor substrate such as GaAs, SiC, and GaN, or a glass or ceramics substrate used for a liquid crystal display device.

The above-described embodiments of an element wire contact prevention member and a method for maintenance of a heater device may provide the following advantageous functional results: since the element wire contact prevention member is interposed between the heater element wires in a portion at which a gap between the heater element wires becomes narrower due to deformation of the heater element wires than that at the time of arrangement of the heater element wires, it is possible to prevent contact, fusion, and disconnection between the heater element wires.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An insulative element wire contact prevention member, installed in a heater device having heater element wires spirally wound around the circumference of an object to be heated, wherein the element wire contact prevention member is interposed between the heater element wires in a portion at which a gap between the heater element wires becomes narrower than that at the time of arrangement of the heater element wires due to deformation of the heater element wires.

2. An insulative element wire contact prevention member, installed in a heater device having heater element wires having a wave shape or a bent shape of a repeated U-turn pattern disposed on the circumference of an object to be heated, wherein the element wire contact prevention member is interposed between the heater element wires in a portion at which a gap between the heater element wires becomes narrower than that at the time of arrangement of the heater element wires due to deformation of the heater element wires.

3. The insulative element wire contact prevention member of claim 1, wherein the element wire contact prevention member is made of ceramics.

4. The insulative element wire contact prevention member of claim 1, wherein an adiabatic layer is disposed on the circumference of the heater element wires.

5. The insulative element wire contact prevention member of claim 1, wherein the element wire contact prevention member is supported by being inserted between the heater element wires.

6. The insulative element wire contact prevention member of claim 1, wherein the element wire contact prevention member is supported by perpetrating a leading end of the member in the adiabatic layer.

7. The insulative element wire contact prevention member of claim 1, wherein the heater device is disposed on the circumference of a vertical processing container accommodating the object to be heated.

8. The insulative element wire contact prevention member of claim 1, wherein the heater device is disposed on the circumference of a container accommodating the object to be heated.

9. A method for maintenance of a heater device having heater element wires spirally wound around the circumference of an object to be heated, comprising:
detecting a portion at which a gap between the heater element wires becomes narrower than that at the time of arrangement of the heater element wires due to deformation of the heater element wires; and
mounting an element wire contact prevention member between the heater element wires in the narrowed portion.

10. A method for maintenance of a heater device having heater element wires having a wave shape or a bent shape of a repeated U-turn pattern disposed on the circumference of an object to be heated, comprising:
detecting a portion at which a gap between the heater element wires becomes narrower than that at the time of arrangement of the heater element wires due to deformation of the heater element wires; and
mounting an element wire contact prevention member between the heater element wires in the narrowed portion,
